(19) United States
(12) Patent Application Publication
(10) Pub. No.: US 2021/0311081 A1
(43) Pub. Date: Oct. 7, 2021

(54) RANDOMIZED DISPENSING ORDER

(71) Applicant: HEWLETT-PACKARD DEVELOPMENT COMPANY, L.P., Spring, TX (US)

(72) Inventors: David H. Ochs, Corvallis, OR (US); Kenneth Ward, Corvallis, OR (US); Jeffrey A. Nielsen, Corvallis, OR (US)

(73) Assignee: HEWLETT-PACKARD DEVELOPMENT COMPANY, L.P., Spring, TX (US)

(21) Appl. No.: 17/267,217

(22) PCT Filed: Nov. 2, 2018
(86) PCT No.: PCT/US2018/058853

§ 371 Date: Feb. 9, 2021

(51) Int. Cl. G01N 35/00; B41J 29/393

(52) U.S. Cl. CPC G01N 35/0092; B05B 12/16; G01N 2035/0093; B41J 29/393

(57) ABSTRACT

A system for dispensing liquid onto a substrate, the system including: a liquid ejector to dispensing liquid droplets onto the substrate; and a motion controller to provide relative motion between the liquid ejector and the substrate, wherein the order of droplet dispensing is randomized relative to deposition locations on the substrate for a first plurality of the dispensed droplets.

### BACKGROUND

Automated and semiautomated dispensing of liquids have become increasingly common as a way to automate testing and lab work. A liquid autodispening system generally includes a dispensing head and/or ejector capable of dispensing a liquid and a motion controller to provide relative motion between the dispensing head and the targets. The targets have often been vials and/or well plates. Some dispensing systems included the ability to pull liquid for dispensing from a reservoir, for example, in a manner similar to a micropipette. Others include reservoirs loaded with different liquids (e.g., reagents and/or test samples) for the testing/analysis which are loaded by a user prior to use. Autodispensers provide a variety of benefit including reduced touch time by trained lab personnel, consistency in dispensed droplet size, high throughput, ability to accommodate replicates and controls, reduced chance of inadvertent and/or undetectable error. While errors in test plans are still possible, there is at least documentation available to be reviewed. In contrast, if a person puts a droplet in the wrong vial, an erroneous result is difficult to demonstrate.

### BRIEF DESCRIPTION OF THE DRAWINGS

The accompanying drawings illustrate various examples of the principles described herein and are a part of the specification. The illustrated examples do not limit the scope of the claims.

FIG. 1 shows an example of a system for dispensing liquid onto a substrate consistent with this specification.

FIG. 2 shows an example of a deposition order used by a system consistent with the present specification.

FIG. 3 shows an example of a deposition order used by a system consistent with the present specification.

FIG. 4 shows an example of a motion by a fluid ejector in a deposition order used by a system consistent with the present specification.

FIG. 5 shows a method of dispensing with a liquid ejection system consistent with the present specification.

FIG. 6 shows an example of a system for dispensing liquid onto a substrate consistent with the present specification.

FIG. 7 shows an example of a system for dispensing liquid onto a substrate consistent with the present specification.

Throughout the drawings, identical reference numbers designate similar, but not necessarily identical, elements. The figures are not necessarily to scale, and the size of some parts may be exaggerated or minimized to more clearly illustrate the example shown. The drawings provide examples and/or implementations consistent with the description. However, the description is not limited to the examples and/or implementations shown in the drawings.

### DETAILED DESCRIPTION

Some autodispensing systems utilize randomization of position of test samples to reduce the impact of dispensing order on the results. However, while this approach randomizes the variation over a tested variable(s) this randomization of position of test samples does not compensate for differences in dispense order. Further, this approach to randomization may not be useful where the pattern of dispensed droplets is not amendable to reconfiguration, for example, when the droplets is performed to create a particular pattern and/or align with a measurement instrument.

Liquid dispensing systems have been used to deposit droplets into wells on well plates, vials, for example in a vial box, and/or other target comprising multiple millimeters in width and length (assuming depth is the Z axis of the well/vial). However, recently testing has begun to move to even smaller volumes of tested material. This approach allows more samples (replicates) from a given volume of liquid. For some reactions, droplet based testing has additional favorable properties, such as reaction kinetics, heat dissipation, diffusion distance, and/or etc. Further, liquid dispensing of small droplets has become increasingly precise allowing tighter control over the relative proportions in a droplet. The result is that tests that might have been run with 100 to 500 microliters of liquid may now be run in smaller volumes, including less than 100, 50, 20, 10, 5, 3, or even 1 microliter.

There are some limitations to how small the reaction volume can be while still obtaining good testing results. For example, if the variation in dispensing volume becomes large compared with the total reaction volume for the test, that variation can introduce undesired variation in the results. This may be mitigated by using more samples/replicates.

Another concern is assuring good mixing of multiple droplets used to form the reaction volume. As the droplet volume decreases, the dimensions of the droplet also decrease. If the second, and/or subsequent droplets do not overlap, the desired mixture of liquids will not be present. Further, this may result in two adjacent droplets during any evaluation/measurement operations. When the volumes of liquid involved are larger the accuracy tolerates more variation. However, as the volumes decrease, the target size decreases, while the X and Y positional variation may remain unchanged. For ejector systems with multiple ejectors, variation between the ejectors may come into play. For ejector systems with relative motion, the relative motion between the dispenser and target come into play.

All mechanical systems include some variation between parts. This variation may result in differences in part preparation, intermediate operations, etc. Parts are not designed to mesh “perfectly.” Instead, some degree of variation between them is included to prevent rejects and/or locking. Consider a peg to be placed into a hole. If the peg is 0.5 cm in diameter and the hole is 0.5 cm in diameter, assuming no friction, about half of the pegs will not fit into the hole (assuming equal variance in the peg diameter and hole diameter). Assuming the pegs and holes are perfectly centered at 0.5 cm (which rarely happens) there will be a distribution around the mean value of the dimension. If the peg is too large and/or the hole is too small, the peg will not fit into the hole. Similarly, if the hole is too large and the peg too small, the peg may not be adequately retained by the hole. This issue is fundamental to machine design. Further, while this example includes matching just two measurements, in actual machines, the “stackup” of variation may include the variation of a large number operations. For example, if the hole is relative to an edge, then the offset between the edge and the hole provides another source of variation. If the peg needs to contact something (such as a slot on another piece), then the stackup of the slot dimensions and offset add to the cumulative variation. A variety of design solutions exist to address these challenges, including minimizing part to part variation, determining tightly controlled dimensions vs. non-tightly controlled dimensions, inspecting and sorting, rework, and designing in tolerance. For example, going back to the peg/hole example, the hole may be specified larger than the peg so that instead of 50% of combinations failing to fit, the number is reduced. The amount of reduction from non-fit between the two parts will depend on the size distributions of the two features and the extra distance allowed.

Such mechanical stack up issues may be found in nearly all mechanical systems. However, in practice it is desirable that the impact of the stack up be small compared with the operation being performed. However, as liquid deposition systems have moved from larger volumes to smaller volumes the issues of mechanical stackup have become more relevant. While one solution is to decrease the tolerances of the various relevant parts, that approach may be expensive. Further, the tolerances may need to account for wear. If so, tight tolerances may produces a reduced service life for parts, necessitating more frequent changeout. The use of different materials and production processes may be used to reduce variation, however, this may have other costs and/or design consequences. As with any optimization, adding additional factors may further constrain the design space.

This specification describes a method of minimizing the impact of the part variation. Applicants noted that the relative translation of the liquid ejector to the target impacted prior to deposition impacted the actual position of the deposited droplet on the target. Consider an example with a liquid ejector which can only move in X. If the liquid ejector moves a long distance in a positive direction in X and then stops, the printhead will stop against a tolerance stackup in the +X direction. In contrast, if the printhead moves a long distance in the negative direction in X and then stops, the printhead will stop against a tolerance stack up in the −X direction. As discussed above, in theory it would be nice for these two stackups to be zero and the printhead have the same X position regardless of whether the last motion was positive or negative, in practice there will be variation depending on the direction of last motion and the associated stackup. Further, the distance traveled of last motion may further impact the position of the liquid ejector. If the motion maxes out the kinetic energy of the liquid ejector, then the liquid ejector will reach a stop at its furthest possible position. However, if the kinetic energy is below maximum, the printhead may not reach the stop and can be anywhere between the two stops (positive and negative).

In some examples, the last motion may be applied as a motion in multiple and/or all axes of motion to set all the positions relative to the stops simultaneously. In an example, the last motion is a set of motions applied on different axes sequentially, for example, first X, and then Y. The last motion may further involve overshooting the target location and then coming back to the target deposition location to produce a reproducible offset from the stops in the system. These approaches can allow more precise positioning relative to the stops on the various axes without costly secondary screening of parts and/or narrowing of specification stackups. However, the longer travel distance per deposition may slow throughput on a system.

Further, the liquid ejector itself can vary over time. For example, a dispenser nozzle that has been idle for a long time may become partially plugged. As a result, the first few drops may have a lower volume than subsequent drops until the partial plug has broken free. Other factors such as evaporation and/or temperature can change the dispensed volume in a systematic manner over time. For example, a dispenser may heat up over time resulting in a related gradual increase in dispensed volume. Thus, decoupling the temporal and spatial components of a dispense protocol has value in reducing the impact of systematic variation in the dispenser itself.

As used in this specification and the associated claims, the term liquid includes any liquid, including liquids that are solvent based and liquids that contain solids (e.g. slurries, colloids) and/or other phases (e.g. emulsions) for example, test samples, reagents, indicators, etc. Some example liquids includes aqueous-based pharmaceutical compounds, aqueous-based biomolecules including proteins, enzymes, lipids, antibiotics, Mastermix, DNA samples, cells, and/or blood components, all with optional additives, such as surfactants or glycerol.

Among other examples, this specification describes a system for dispensing liquid onto a substrate, the system including: a liquid ejector to dispense liquid droplets onto the substrate; and a motion controller to provide relative motion between the liquid ejector and the substrate, wherein the order of droplet dispensing is randomized relative to deposition locations on the substrate for a first plurality of the dispensed droplets.

Among other examples, this specification also describes a method of dispensing with a liquid ejection system, the method including, with a processor controlling the liquid ejection system: receiving a test plan of droplets to be applied with the liquid ejection system to a substrate; randomizing order of application of droplets to be independent of relative positions of the droplets on the substrate; moving a liquid ejector of the liquid ejector system relative to the substrate to a next location for deposition; depositing a planned amount of liquid at the next location; and repeating the operations of moving the liquid ejector and depositing the planned amounts of liquid until all the droplets on the test plan have been applied to the substrate.

This specification also describes a system for dispensing liquid onto a substrate, the system including: a liquid ejector to dispense liquid droplets onto the substrate; and a motion controller to provide relative motion between the liquid ejector and the substrate, wherein the order of droplet dispensing is randomized between continuous portions of the substrate and randomized relative to the substrate position for the dispensed droplets and wherein the fluid ejector moves to a position with a fixed direction and distance offset from a dispense location and pauses prior to moving the dispense location.

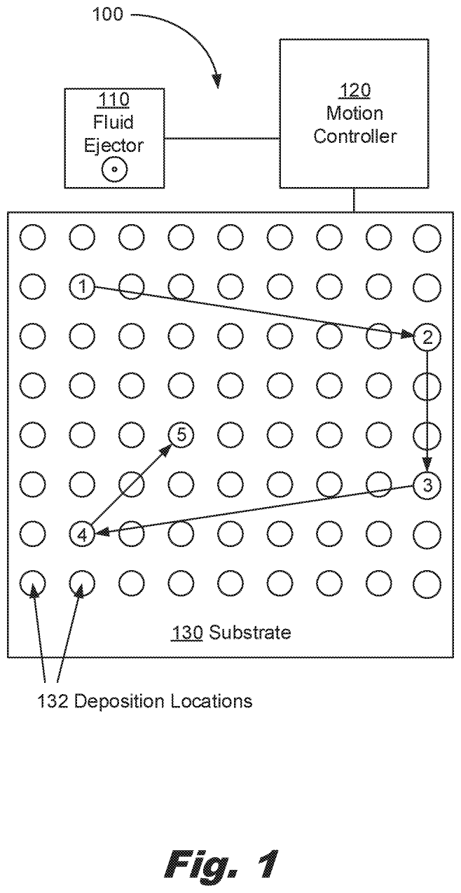

Turning now to the figures, FIG. 1 shows an example of a system (100) for dispensing liquid onto a substrate (130) consistent with this specification. The system (100) includes: a liquid ejector (110) to dispense liquid droplets onto the substrate (130); and a motion controller (120) to provide relative motion between the liquid ejector (110) and the substrate (130), wherein the order of droplet dispensing is randomized relative to deposition locations (132) on the substrate (130) fora first plurality of the dispensed droplets.

In FIG. 1 there are 5 different deposition locations marked 1, 2, 3, 4, and 5. Arrows show paths of the liquid ejector (110) relative to the substrate (130) allowing deposition of the liquid at the various locations in a random order. This contrasts with the incrementing down a row and/or column used when dispensing liquids onto substrates (130) such as well plates, vials, and/or prepared surfaces. The use of a random liquid deposition order breaks possible links between deposition location and liquid deposition order which may otherwise confound the results.

The system (100) is a liquid ejection system (100). Such systems may be used to perform automated testing, mixing, and/or processing of liquids. The system (100) may include an internal liquid reservoir containing the liquid to be dispensed. The system (100) may include multiple internal liquid reservoirs containing different liquids. In some examples, the system (100) is able to load liquid from an external source, such as a vial and/or similar container. The liquid ejection system (100) includes a liquid ejector (110) to deposit the liquid(s) onto a substrate (130).

The liquid ejector (110) deposits liquid onto a substrate (130) at deposition locations (132). The liquid ejector (110) may be modeled on a micropipette, syringe, needle, etc. The liquid ejector (110) may be a printhead, for example a thermal inkjet (TIJ) and/or piezoelectric inkjet (PIJ). The liquid ejector (110) may deposit droplets one at a time. The liquid ejector (110) may deposit multiple droplets simultaneously. The liquid ejector (110) may deposit droplets while in motion relative to the substrate (130). The liquid ejector (110) may cease motion relative to the substrate (130) when depositing a droplet.

The motion controller (120) controls relative motion between the liquid ejector (110) and the substrate (130). In some examples, the motion controller (120) provides two axes of motion (X and Y) in the liquid ejector (110). The motion controller (120) may provide two axes of motion (X and Y) in the substrate (130). The motion controller may provide an axis of motion in the liquid ejector (110) and another axis of motion in the substrate (130). The motion controller (120) may provide more axes of motion, for example, in the Z direction (up and down) compared to a surface of the substrate (130). Other axes of motion may be included for other purposes, for example, changing out the dispense tip, loading the dispenser, storage, etc.

The motion controller (120) may implement the motion of the liquid ejector (110) and/or substrate (130) using motors, actuators, pistons, gears, and/or similar components. The motion controller (120) may include a sensor to detect a registration feature or features. In an example, the motion controller (120) may use a previously deposited droplet at a deposition location (132) as a registration feature. The motion controller (120) may use wells in a well plate, vials in a tray, and/or similar features as registration features. The motion controller (120) may use printing and/or a label on the substrate (130) as registration features.

The motion controller (120) may use the sensor to verify that the deposited droplet is not separate from a target droplet on the substrate (130). In an example, the sensor is an optical sensor, for example, a video camera.

The substrate (130) is the surface which receives deposited droplets from the liquid ejector (110). The substrate (130) may include topographical features, such as wells, lines, ridges, etc. The substrate (130) may include areas of chemical modification, for example, to make some areas hydrophilic and surrounding areas hydrophobic. The substrate (130) may include printing and/or other identification. The substrate (130) may include registration features as discussed above.

The substrate (130) may have areas and/or a surface preloaded with a reagent. In an example, the substrate (130) is preloaded with the reagents for a reaction and just needs the sample and a solvent applied to conduct a test. The reagents may be applied in specific areas, e.g. dots and/or deposition locations (132). The reagents may be applied uniformly on the substrate (130), for example, to speed manufacture.

The deposition locations (132) are on the substrate (130). In some examples, the deposition locations (132) are organized in a pattern. For example, the deposition locations (132) in FIG. 1 form a grid. A variety of other patterns may be used. The droplets may be organized into clusters. For example, two reagents may be deposited adjacent to each other and then merged by a third droplet. In an example, the droplets are organized into clusters using a first type of liquid ejector (110) and then a second type of liquid ejector (110) is used to rapidly combine the droplets on the substrate (130) using a liquid with reduced concentration and/or larger volumes. The droplets may be organized so that the droplets produce a visible pattern and/or design. For example, the positions of the droplets may be used to encode information such as a test identifier and/or test number.

The deposition locations (132) may be previously deposited droplets of liquid on the substrate (130). As discussed above, the movement to droplet based reactions may involve deposition locations (132) which are substantially smaller than previous reaction volumes. The small reaction volume correlates with a small diameter of the deposition location (132). If the new droplet doesn't overlap with the previously deposited droplet, the components will not mix and the planned reaction will not take place. In some examples, the previous and/or new droplet size is below 100 pL, 50 pL, 20 pL, 10 pL, and/or below 5 pL. When both droplets are small, the targeting tolerances become increasingly sensitive to positional reproducibility of the liquid ejector (110) with respect to the substrate (130). In practice, with small enough fluid volumes, the last motion prior to deposition, both direction and peak velocity, may impact the ability to deposit a new droplet on top of an existing droplet serving as a deposition location (132). As will be discussed below, one way to reduce misses is to provide the same motion (direction and peak speed) prior to each liquid deposition to provide consistency of the relative position between the liquid ejector (110) and the substrate (130). Randomization can also reduce systemic error from the motion prior to deposition. In contrast, going down a column and then resetting to the top of the next column produces a noticeable systemic error in the positioning of the first droplet in the column compared with the other droplets in the column.

Randomization of droplet dispense order reduces in the confounding of test results with dispense order. Randomization of droplet dispense order also reduces the systemic error associated with moving the fluid ejector place by place down a row.

Randomization may be true randomization across all deposited droplets. However, other randomization approaches may offer additional benefits in minimizing variation, time, and other factors. In an example, the substrate (130) is divided into a number blocks. The randomization may then be rotated through the blocks to assure some amount of movement of the liquid ejector (110) between depositions. In some examples, sequential blocks alternate between edge and interior blocks. In some examples, the deposition proceeds by blocks, so all of a first block is completed in random order and then the system (100) moves on to a second block. A block may be a row, column, and/or other area on the substrate. The blocks may be formed as rings and/or parts of rings based on the distance from an edge. For example, all the deposition locations (132) with no deposition locations between themselves and an edge of the substrate (130) may form a ring on the substrate as the first block. The second block could be deposition locations with just deposition locations of the first block between themselves and an edge of the substrate (130) and so on. Such ring blocks may be halved, quartered, and/or otherwise divided to distribute the order radially as well as by the distance from the center of the substrate (130). Such rings need not be circular. For example, square and/or rectangular frame-like rings may be used.

The deposition may be performed by pluralities of droplets. For example, one plurality of droplets may be randomized across a first block as discussed above. The first plurality may make up half of the dispensed droplets and a subsequent second plurality is dispensed in a non-randomized order.

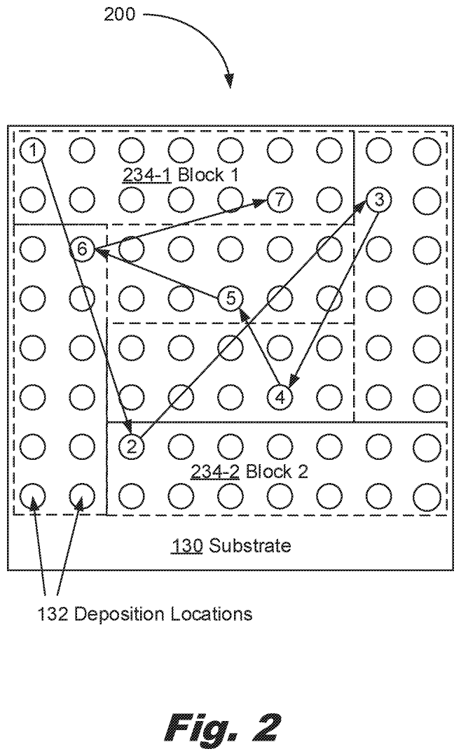

FIG. 2 shows an example of a deposition order used by a system (200) consistent with the present specification. FIG. 2 shows a substrate (130) having a number of deposition locations (132) which are grouped into blocks (234).

The blocks (234) may be ordered randomly and/or based on their position (e.g., interior/exterior). The deposition order randomly selects a deposition location (132) in the first block (234-1). The liquid ejector (110) deposits the liquid at this location (132-1). The motion controller (120) then positions the liquid ejector (110) over a deposition location (132) randomly selected in the second block (234-2). The liquid ejector (110) then deposits liquid at the deposition location (132-2). This process continues until each block has a single deposition location and then proceeds to repeat for a second deposition location in each block (234) and so forth until all the deposition locations (132) have received their programmed amount of fluid. The order of the blocks maybe repeated with each cycle. The order of blocks may be randomized with each cycle. In an example, the blocks (234) are test groups and/or replicate groups in a test plan. The blocks (234) may be continuous as shown. The blocks (234) may be non-contiguous; this may use additional checks to avoid missing locations and/or producing undesirable clumping of deposition locations.

In another form of limited randomization, the next deposition location (132) may instead be limited to deposition locations (132) with a minimum separation from the current deposition location (132). For example, adjacent deposition locations may be excluded and/or deposition locations (132) in the same row and/or column may be excluded from the set of possible next deposition locations (132). In some example these randomization with restrictions may be less likely to produce conflicts when used for an initial group of deposition locations (132) and after the first percentage have been randomly deposited, the remainder are deposited in a row by row manner. The percentage may be 25%, 40%, 50%, 60%, 70%, 75%, and/or some other number of deposition locations (132).

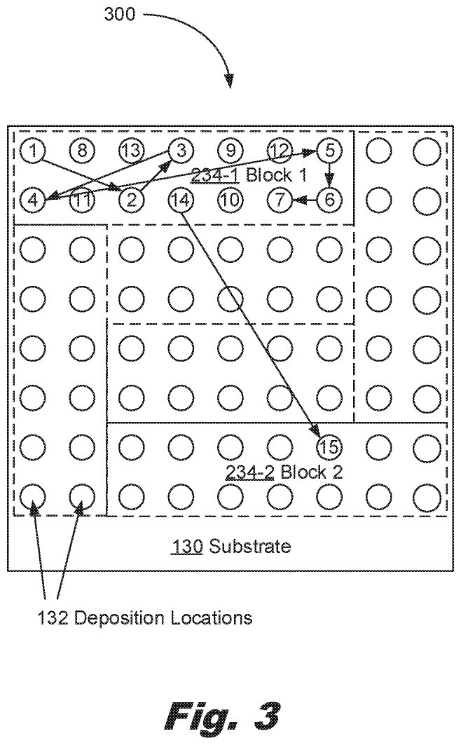

FIG. 3 shows an example of a deposition order used by a system (300) consistent with the present specification. FIG. 3 shows a substrate (130) having a number of deposition locations (132) which are grouped into blocks (234). In this example, the deposition locations (132-1 to -14) in a first block (234-1) are randomly ordered to receive liquid from the liquid ejector (110). Once all the deposition locations (132) in the first block (234-1) have received their planned liquid, the system (300) moves to a new block (234-2) and continues the process. Deposition locations in the second block (234-2) are randomly ordered and each deposition location (132) in the second block (234-2) is treated prior to moving on to the third block (234).

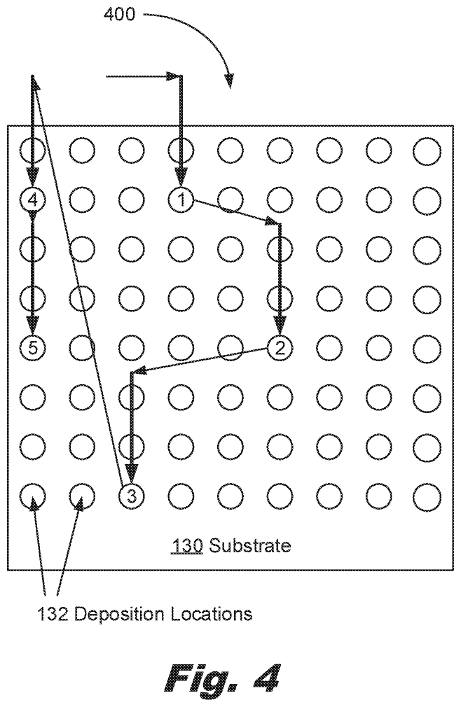

FIG. 4 shows an example of a motion by a fluid ejector (110) in a deposition order used by a system (400) consistent with the present specification. The fluid ejector (110) moves relative to the substrate (130) tracing a path defined by the arrows. For each deposition location (132) to receive liquid, the fluid ejector (110) first moves to a fixed standoff in direction and orientation from the deposition location (132). The system (400) then moves the predetermined direction and distance to produce a consistent position relative to the stops in the system (400) when depositing the droplet.

The motion from the predetermined distance and direction may be performed first in one axis (e.g., X) and then in a second axis (Y). In an example, the motion from the predetermined distance and direction may be in both and/or all axes of motion available to the system (400). The predetermined distance and direction should be far enough to allow sufficient speed to reliable set the position of the fluid ejector relative to its stops in the system (400). In an example, the motion in the predetermined distance and direction may move past the target deposition location (132) and then reverse 180 degrees to obtain reproducible positioning.

This premove-final approach technique may be used on all droplets deposited by the liquid ejector (110). This premove-final approach technique may be used for droplets where the additional precision of the droplet relative to the target is needed. The premove-final approach maybe omitted when the associated move strategy does not improve the results. For example, if three small droplets are placed in close proximity and then joined using a larger droplet, the premove-final approach may be used to position the smaller droplets but may not be needed for the larger final droplet, allowing faster deposition of the final droplet and less time between the start of the final droplets being applied and the last final droplet being applied.

In these examples, the relative motion between the liquid ejector (110) and the substrate (130) is the same before each dispense operation by the liquid ejector (110). More complex approaches which track the position of the liquid ejector (110) relative to the stops may be tracked based on the motion plan. This information may then be used to create custom final approaches to standardize the position of the liquid ejector (110) relative to the stops. This is computationally more complex but may reduce the total process time by reducing the final approach distances.

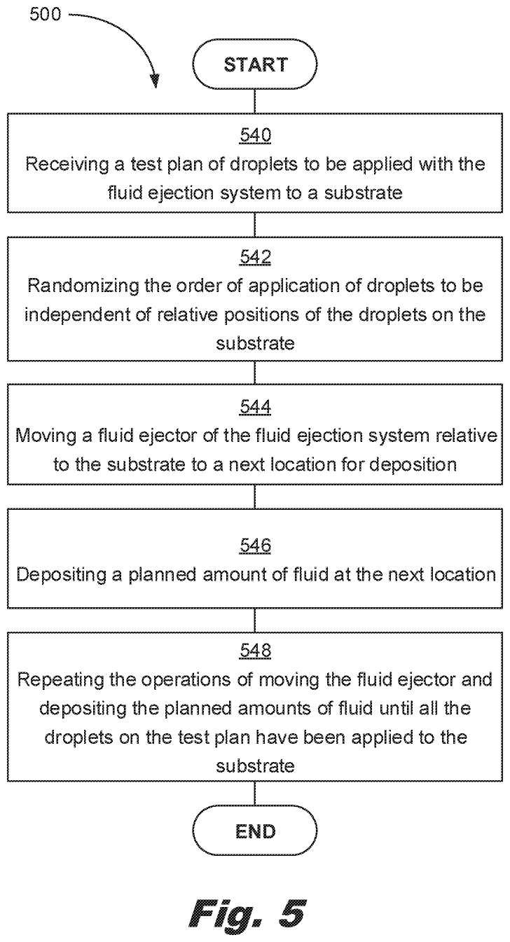

FIG. 5 shows a method (500) of dispensing with a liquid ejection system (100) consistent with the present specification. The method (500) including, with a processor controlling the liquid ejection system (100): receiving a test plan of droplets to be applied with the liquid ejection system (100) to a substrate (130) (540); randomizing order of application of droplets to be independent of relative positions of the droplets on the substrate (130) (542); moving a liquid ejector (110) of the liquid ejector system (100) relative to the substrate (130) to a next location for deposition (544); depositing a planned amount of liquid at the next location (546); and repeating the operations of moving the liquid ejector (110) and depositing the planned amounts of liquid until all the droplets on the test plan have been applied to the substrate (130) (548).

The method (500) is a method of dispensing with a liquid ejection system (100). The method (500) may reduce confounding between sample position and deposition order. The method (500) may reduce variation between test samples and/or test sample sets. The method (500) may increase repeatability of deposition between multiple droplets deposited as a given deposition location (132). The method (500) may increase reliability of mixing droplets deposited at a deposition location (132).

The method (500) includes receiving a test plan of droplets to be applied with the liquid ejection system (100) to a substrate (130) (540). The test plan may be provided in a variety of formats. The test plan may be randomized prior to provision to system (100). The test plan may be provided on a piecemeal basis, for example, one move at a time, and/or as a cluster of depositions.

The method (500) includes randomizing order of application of droplets to be independent of relative positions of the droplets on the substrate (130) (542). The position of the various runs of the test plan may also be randomized against the substrate. A variety of approaches to randomization are discussed above. These vary from complete randomization to partial randomization. Group based (between and/or within) randomization and/or randomization for a first number of droplets followed by non-randomized deposition for a remaining number of droplets is another method to decrease the impact of deposition order with less impact on test time.

The method (500) includes moving a liquid ejector (110) of the liquid ejector system (100) relative to the substrate (130) to a next location for deposition (544). The motion may be performed by moving the liquid ejector (110), moving the substrate (130), and/or both. Motion may be in two axes, e.g., X and Y. Motion may include a Z component.

The method (500) includes depositing a planned amount of liquid at the next location (546). The amount of liquid deposited at the location is dependent on the test plan. In some examples, all locations of the test plan receive a first amount of liquid. In some examples, different locations receive different amounts of at least one liquid. For example, more of a test solution may be applied to some locations to produce a response curve. Different amounts of reagents and/or different reagents may be used at different locations.

The method (500) includes repeating the operations of moving the liquid ejector (110) and depositing the planned amounts of liquid until all the droplets on the test plan have been applied to the substrate (130) (548). All the droplets in the test plan may be a subset of all the droplets to be deposited on the substrate (130). In an example, all the droplets of the test plan include all the droplets to be applied to the substrate (130). In an example, the test plan covers a randomized portion and not a subsequent randomized portion.

The method (500) may further include other operations, such as dividing the substrate (130) into regions wherein the randomization rotates through the regions. In an example, the regions correspond to different test groups in the test plan. The regions may alternate between border regions and interior regions of the substrate

The method may further include, prior to moving the liquid ejector (110) relative to the substrate (130) to the next location for deposition, moving the liquid ejector (110) relative to the substrate (130) to be a fixed distance and direction from the next location for deposition and stopping the relative motion of the liquid ejector (110) the at the fixed distance and direction prior to moving to the next location for deposition.

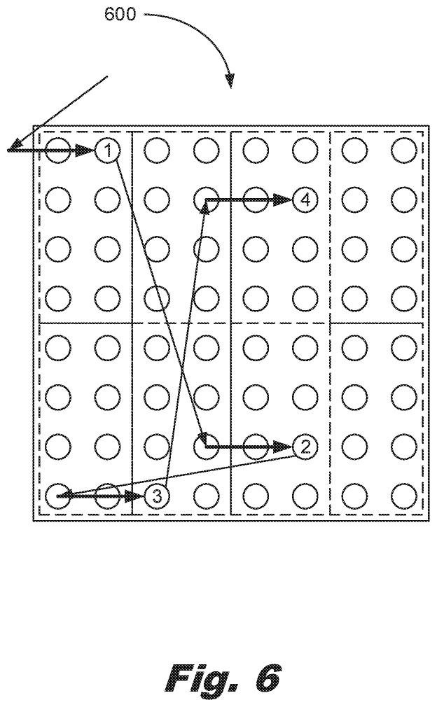

FIG. 6 shows an example of a system (600) for dispensing liquid onto a substrate consistent (130) with the present specification. The system (600) including: a liquid ejector (110) to dispense liquid droplets onto the substrate (130); and a motion controller (120) to provide relative motion between the liquid ejector (110) and the substrate (120), wherein the order of droplet dispensing is randomized between continuous portions of the substrate and randomized relative to the substrate (130) position for the dispensed droplets and wherein the fluid ejector (110) moves to a position with a fixed direction and distance offset from a dispense location and pauses prior to moving the dispense location.

This example combines the use of blocks (234) with the use of the movement prior to movement to the deposition location (132) to minimize variation in positioning due to the recent direction and magnitude of motion by the liquid ejector (110) relative to the substrate (130). These approaches may further be augmented by randomizing sample locations to positions on the substrate to reduce edge effects.

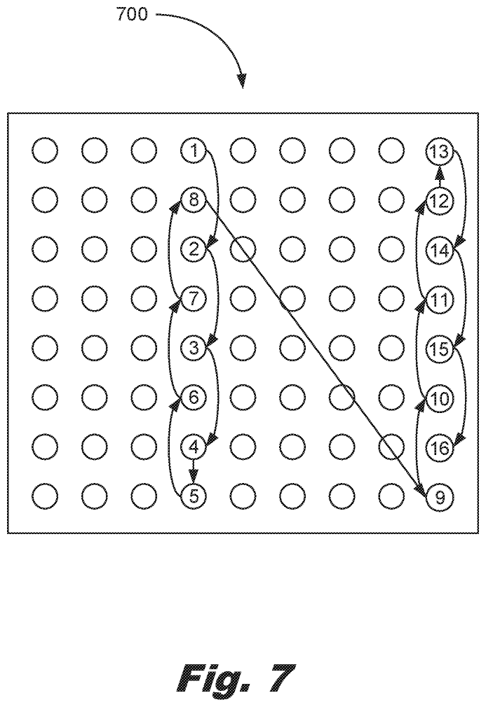

FIG. 7 shows an example of mixed randomization by a system (700). The fluid ejector (110) is randomized to a row but skips deposition locations (132) on first pass in a first direction and fills in the skipped deposition locations (132) on a return pass in the direction opposite the first direction. The system (100) then moves to a random row. In the shown pattern, the system (700) moves to the alternate side of the substrate (130) to begin the second row. The system (700) may move to the same side but invert the pattern of deposition locations (132) in the first and second passes. A variety of such combinations of random and orderly deposition may be used to provide tradeoffs between confounding and other factors.

The system (700) may randomize the order of deposition for a first group of deposition targets (132) on a substrate (130) and then systematically fill in the remaining deposition targets (132). For example, the first group may be 25%, 50%, 60%, or some other percentage of the deposition targets (132). The use of randomization of one group followed by row by row deposition of a second group may allow assessment of variation in the test group from the deposition method. This may be particularly useful if the deposition pattern includes replicates and/or control samples. In another example, the deposition pattern traces a spiral into the center of the substrate (130) alternating or depositing every Xth (2^{nd}, 3^{rd}, 4^{th}) deposition location (132). The system (700) may then trace the spiral back out. The system (700) may change to linear deposition for the remaining deposition locations (132), use a random or semi-random approach as described above, or use a combination of deposition patterns to break up a deposition order/position correlation.

It will be appreciated that, within the principles described by this specification, a vast number of variations exist. It should also be appreciated that the examples described are only examples, and are not intended to limit the scope, applicability, or construction of the claims in any way.

What is claimed is:

1. A system for dispensing liquid onto a substrate, the system comprising:
a liquid ejector to dispense liquid droplets onto the substrate; and
a motion controller to provide relative motion between the liquid ejector and the substrate, wherein the order of droplet dispensing is randomized relative to deposition locations on the substrate fora first plurality of the dispensed droplets.

2. The system of claim 1, wherein deposition locations on the substrate are droplets of liquid.

3. The system of claim 1, further comprising randomizing positions of test samples on the substrate.

4. The system of claim 1, wherein the randomization is by blocks, such that all randomized deposition locations in a first block are serviced prior to commencing servicing of a deposition location in a second block.

5. The system of claim 1, wherein the randomization is between blocks.

6. The system of claim 1, wherein a relative motion between the liquid ejector and the substrate is the same before each dispense operation by the liquid ejector.

7. The system of claim 1, wherein the first plurality comprises all the dispensed droplets.

8. The system of claim 1, wherein the first plurality comprises half of the dispensed droplets and a subsequent second plurality are dispensed in a non-randomized order.

9. A method of dispensing with a liquid ejection system, the method comprising, with a processor controlling the liquid ejection system:
receiving a test plan of droplets to be applied with the liquid ejection system to a substrate;
randomizing order of application of droplets to be independent of relative positions of the droplets on the substrate;
moving a liquid ejector of the liquid ejector system relative to the substrate to a next location for deposition;
depositing a planned amount of liquid at the next location; and
repeating the operations of moving the liquid ejector and depositing the planned amounts of liquid until all the droplets on the test plan have been applied to the substrate.

10. The method of claim 9, wherein the substrate is divided into regions and the randomization rotates through the regions.

11. The method of claim 10, wherein the regions correspond to different test groups in the test plan.

12. The method of claim 10, wherein the regions alternate between border regions and interior regions of the substrate

13. The method of claim 9, further comprising, prior to moving the liquid ejector relative to the substrate to the next location for deposition, moving the liquid ejector relative to the substrate to be a fixed distance and direction from the next location for deposition and stopping the relative motion of the liquid ejector at the fixed distance and direction prior to moving to the next location for deposition.

14. A system for dispensing liquid onto a substrate, the system comprising:
a liquid ejector to dispense liquid droplets onto the substrate; and
a motion controller to provide relative motion between the liquid ejector and the substrate, wherein the order of droplet dispensing is randomized between continuous portions of the substrate and randomized relative to the substrate position for the dispensed droplets and wherein the fluid ejector moves to a position with a fixed direction and distance offset from a dispense location and pauses prior to moving the dispense location.

15. The system of claim 14, wherein samples are randomized to positions on the substrate to reduce edge effects.
